(19) United States
(12) Patent Application Publication
(10) Pub. No.: US 2008/0234121 A1
(43) Pub. Date: Sep. 25, 2008

(54) Automatic Balancing Centrifugal Apparatus By Fluid Compsensation

(75) Inventors: Hak Chul Kim, Gyeonggi-do (KR); Chong Tae Park, Seoul (KR)

Correspondence Address: SCHMEISER OLSEN & WATTS, 18 E UNIVERSITY DRIVE, SUITE # 101, MESA, AZ, 85201, US

(73) Assignee: HANLAB CORPORATION, Gyeonggi-do (KR)

(21) Appl. No.: 10/597,439

(22) PCT Filed: Sep. 15, 2005
(86) PCT No.: PCT/KR2005/003065

§ 371 Date: Jul. 25, 2006

(30) Foreign Application Priority Data
Nov. 19, 2004 (KR) 10-2004-0094893

(51) Int. Cl. B04B 9/10

(52) U.S. Cl. 494/8

(57) ABSTRACT

The invention relates to an automatic balancing centrifugal apparatus by fluid compensation, which compensates a load imbalance among buckets holding samples by injecting a fluid into the buckets or sucking the fluid from the buckets, thereby simplifying the overall structure of the centrifugal apparatus, increasing the durability, and centrifuging a large quantity of samples under various high-speed rotation conditions smoothly. The automatic balancing centrifugal apparatus by fluid compensation comprises: rotors on which a plurality of buckets are mounted; a centrifuge motor for rotating said rotors; a load measurement mechanism, which is installed so as to lift and lower along the rotation trace of said buckets and which measures the load of said buckets while the restraint of the buckets is being released at the time of lifting; a position sensing mechanism for sensing whether or not each of said buckets is positioned right above said load measurement mechanism; a fluid compensation mechanism for injecting a fluid into said buckets or for sucking the fluid from the buckets; and a main control part for controlling the overall operations of each of said elements and for controlling said fluid compensation mechanism so that the loads of said buckets can become equal to each other.

### TECHNICAL FIELD

The invention relates to an automatic balancing centrifugal apparatus by fluid compensation, and particularly to an automatic balancing centrifugal apparatus by fluid compensation which is capable of compensating a load unbalance among buckets holding samples by injecting a fluid into the buckets or sucking the fluid from the buckets.

### BACKGROUND ART

A centrifugal apparatus is one which rotates rotors holding samples at high speed to apply a large centrifugal acceleration to the samples, so that high-density sample components can be placed on an outer layer in a radial direction and low-density sample components can be placed on an inner layer in a radial direction to separate the components from each other. An automatic balancing centrifugal apparatus is one, which calculates load differentials of each bucket, which inevitably occur due to the number of samples or the load differentials of each sample held in each bucket, and the like, and automatically maintains a balance before centrifugation.

FIG. 1 is a schematic perspective view of a conventional automatic balancing centrifugal apparatus by lever movement. As shown in FIG. 1, the conventional automatic balancing centrifugal apparatus by lever movement comprises a centrifuge motor (2); a rotor (20) which is axially bonded to the centrifuge motor (2) to be rotated; a rotor lever (22) which rotates while supporting buckets (40) and is supported so as to be capable of being horizontally moved with respect to the rotor (20); an elevator-type load measurement mechanism (hereinafter “load measurement mechanism”) which measures the loads of both buckets (40) before centrifugation in order to sense the load unbalance of both buckets (40); a slip ring (50) which is fixed in a given place to a centrifuge motor shaft (4) and extends from the power lines and signal lines of electrical/electronic components within the rotor (20) to be exposed to the outside; and a wiring terminal carrier (60) which extends from the external power lines and signal lines and mounts a wiring terminal (not shown) disposed in one-to-one correspondence with the slip ring (50) to contact and separate with respect to the slip ring (50). Reference numeral 22A indicates bucket support arms formed on the rotor lever (22), and reference numeral 42 indicates a locking groove which is formed on the bucket (40) and is locked in the bucket support arms (22A). Meanwhile, the conventional automatic balancing centrifugal apparatus by lever movement may further comprise a position sensor (not shown) for positioning the bucket (40) right above the load measurement mechanism (30).

In the above-described constitution, an operator lifts a loading plate of the load measurement mechanism (30) before each centrifugation while positioning one bucket (40) right above the load measurement mechanism (30). Then, the operator measures the load of the bucket (40) while the bucket (40) is released with respect to the rotor lever (22), and the operator lowers the loading plate and measures the load of another bucket (40) in the same manner, thereby measuring a load differential between both buckets (40). Thereafter, in order to keep a dynamic balance among samples in the buckets (40) at the time of rotation for centrifugation, a lever carrying motor (not shown) mounted within the rotor (20) is driven to thereby adjust a differential in distance between the bucket (40) and the rotor rotation shaft which corresponds to the load differential of the buckets (40), thereby making centrifugal forces applied to the samples at both ends uniform. To do this, the wiring terminal carrier (60) is moved forward to supply required power and control signals to the lever carrying motor while being in contact with the slip ring (50). Then, the wiring terminal carrier (60) is moved backward to be separated from the slip ring (50). The overall constitution or individual constitutions of the automatic balancing centrifugal apparatus by lever movement are specifically disclosed in Korean Patent No. 343336, entitled “Automatic balance adjusting centrifuge apparatus”; Korean Patent Application No. 2002-17498, entitled “Automatic balance adjusting centrifuge apparatus”; Korean Patent Application No. 2004-26526, entitled “Elevator-type load measurement apparatus”; Korean Patent Application No. 2004-76489, entitled “Automatic balancing rotor for centrifuges”; and Korean Patent Application No. 2004-76490, entitled “Signal transfer apparatus of a rotating body,” filed by the same applicant, and the explanations thereof in detail will be omitted here. All patents and patent applications mentioned herein are incorporated herein by reference.

However, the above-described conventional automatic balancing centrifugal apparatus by lever movement needs a very precise lever carrying mechanism as well as a slip ring being a non-contact electrical connection and an external wiring terminal carrying mechanism in order to supply power or signals to the lever transfer motor. Due to such complex mechanism and electrical characteristics, the conventional automatic balancing centrifugal apparatus by lever movement has a limited durability compared to a typical centrifugal apparatus without automatic balancing function; there is a limit in processing a large quantity of samples due to a limited bucket installation; and there is a problem which cannot centrifuge a sample according to various high-speed rotation conditions.

### DISCLOSURE OF INVENTION

### Technical Problem

The present invention aims to solve these problems of the prior art and to provide an automatic balancing centrifugal apparatus by fluid compensation, which compensates a load unbalance among buckets holding samples by injecting a fluid into the buckets or sucking the fluid from the buckets, thereby simplifying the overall structure of the centrifugal apparatus, increasing the durability, and centrifuging a large quantity of samples under various high-speed rotation conditions smoothly.

### Technical Solution

In order to achieve the above object, an automatic balancing centrifugal apparatus by fluid compensation according to the present invention comprises:

(a) rotors on which plural buckets are mounted;

(b) a centrifuge motor for rotating said rotors;

(c) a load measurement mechanism, which is installed so as to lift and lower along the rotation trace of said buckets;

(d) a position sensing mechanism for sensing whether or not each of said buckets is positioned right above said load measurement mechanism;

(e) a fluid compensation mechanism for injecting a fluid into said buckets or sucking the fluid from said buckets; and

(f) a main control part for controlling the overall operations of each of said elements and controlling said fluid compensation mechanism so that the loads of said buckets can be equal to each other.

### BRIEF DESCRIPTION OF THE DRAWINGS

FIG. 1 is a schematic perspective view of a conventional automatic balancing centrifugal apparatus.

FIG. 2 is a schematic perspective view of an automatic balancing centrifugal apparatus by fluid compensation according to the present invention.

FIG. 3 is a schematic sectional view of a fluid compensation mechanism taken along line A-A of FIG. 2.

FIG. 4 is an electric block diagram of an automatic balancing centrifugal apparatus by fluid compensation according to the present invention.

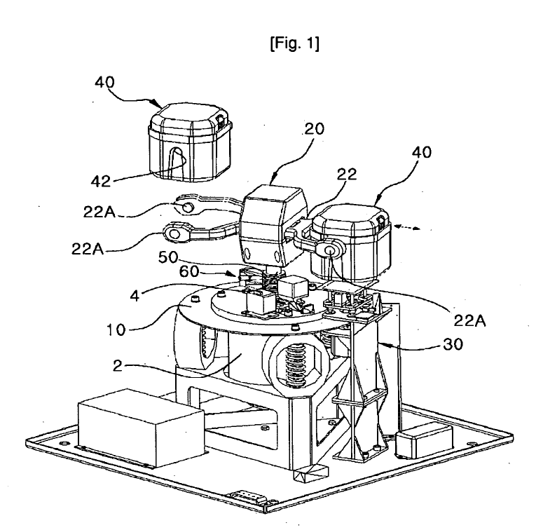

### DESCRIPTION OF THE MAIN REFERENCE NUMBER IN THE DRAWINGS

100 centrifugal apparatus
112 centrifuge motor
102 motor shaft
110 motor top plate
111 bucket positioning sensor
112 rotational speed sensor
113 slit disc
120 rotor
130 load measurement mechanism
131 vertical support
132 elevation motor
133 loading plate
134 photocoupler
135 position indicating marker
136 linear motion guide
140 bucket
141 sample holding plate
141A sample holding hole
142 sample cylinder
150 fluid compensation mechanism base
160 fluid storage tank
161 fluid feeding inlet
162 fluid sucking hole
163 fluid exhaust outlet
171 exhaust pump
172 sucking pump
173 connection tube
174 nozzle
180 elevation motor
182 nozzle support
183 elevation plate
184 slide center
185 linear bush
186 linear motion guide
187 screw shaft
188 position indicating marker
188U upper limit indicating slit
188L lower limit indicating slit
189 photocoupler
200 main control part
202 key input part
204 speed sensing part
206 bucket positioning sensing part
208 indicating part
210 centrifuge motor drive part
212 centrifuge motor
220 load measurement part
222 position sensing part
224 load sensor
226 elevation motor drive part
228 elevation motor
230 fluid compensation part
232 position sensing part
233 elevation motor
234 elevation motor drive part
236 pump drive part
238 pump

### MODE FOR THE INVENTION

Hereinafter, an automatic balancing centrifugal apparatus by fluid compensation according to preferred embodiments of the present invention will be explained in detail with reference to the accompanying drawings.

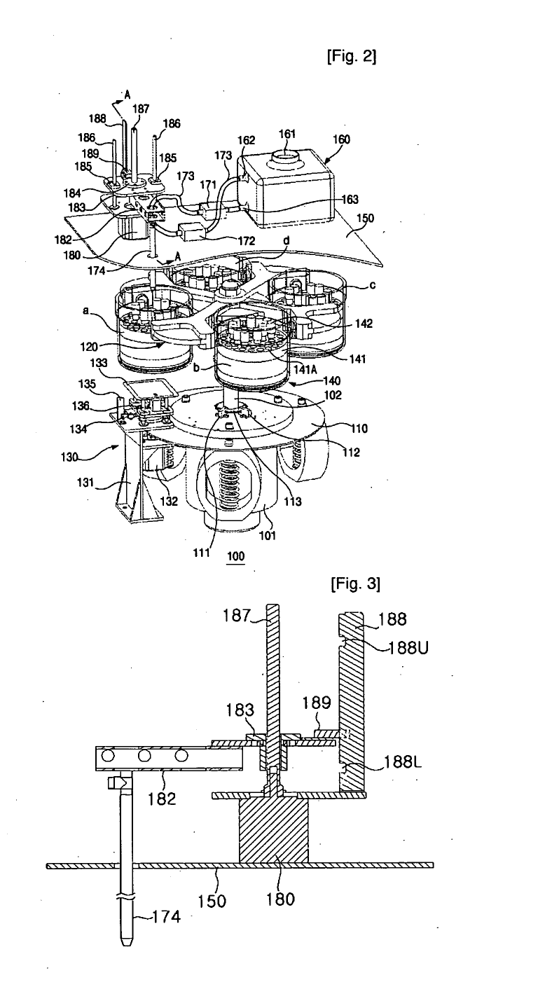

FIG. 2 is a perspective view showing a schematic constitution of an automatic balancing centrifugal apparatus by fluid compensation according to the present invention. FIG. 3 is a schematic sectional view of a fluid compensation mechanism taken along line A-A of FIG. 2. As shown in FIGS. 2 and 3, the centrifugal apparatus by fluid compensation of the present invention may comprise: rotors (120) on which a plurality of buckets (140) are mounted; a centrifuge motor (101) for rotating said rotors (120); a load measurement mechanism (130) which is fixed in a given place and measures the loads of the buckets (140) in a predetermined order; a position sensing mechanism for sensing whether or not the buckets (140) are positioned at a predetermined stationary position, that is, right above the load measurement mechanism (130); and a fluid compensation mechanism which is fixed at a space above the buckets (140) and which injects a fluid into the buckets (140) or sucks the injected fluid from the buckets (140).

In the above-described constitution, the rotors (120) are axially connected at the center thereof with the motor shaft (102), and may comprise either even or odd numbers of rotor arms supporting the buckets (140). However, in either case, each of the rotor arms is preferably formed so as to have the same length from the center of the motor shaft and to be conformal to each other. Reference numeral 110 represents a top plate of the centrifuge motor on which the various necessary components are mounted.

The load measurement mechanism (130) may be embodied as an elevator-type load measurement mechanism as described above, and the loading plate (133) may be installed so as to be positioned right below the rotation trace of the buckets (140). The load measurement mechanism (130) may comprise: an elevation motor (132) for lifting the loading plate (133) toward the buckets (140); a vertical support (131) for supporting the elevation motor (132) and remaining components; a slide center (not shown) which is fixed to the center portion of the loading plate (133) while being screwed to the screw rotation shaft (not shown) of the elevation motor (132) by a female screw formed at the center of the slide center; a linear motion guide (136) for guiding a linear motion of the loading plate (133); a load sensor (not shown) for measuring the load applied to the loading plate (133); a position indicating marker (135) on which slits (not shown) indicating the uppermost and lowermost positions of the loading plate (133) are formed; and a photocoupler (134) which comprises a light emitting element and a photodetector, which are installed on opposite sides of a groove into which the distal end with slits of the position indicating marker (135) is interposed.

The position sensing mechanism may comprise a slit disc (113), which is axially bonded with the motor shaft (102) and in which slits indicating the positioning of each of the buckets (140) are formed on the circumference thereof in a radial direction, and a bucket positioning sensor (111) which comprises a photocoupler including a light emitting element and a photodetector, which are installed on the opposite sides of a groove into which the circumference of the slit disc (113) is interposed. A plurality of slits for measuring velocity are formed on the circumference of the slit disc (113) in a radial direction. The position sensing mechanism further includes a rotational speed sensor (112) comprising a photocoupler for sensing the velocity. In this case, positioning slits must be formed in at least the same number of that of the buckets (140), and velocity measurement slits are formed in more than the number of the positioning slits. Preferably, the length of the positioning slits is formed longer than that of the velocity measurement slits in order to differentiate both from each other.

The buckets (140) may be formed as a cylindrical body having a closed bottom surface, and a sample holding plate (141) for holding sample cylinders is mounted within the buckets (140). The sample cylinders (142) are inserted into a plurality of sample holding holes (141A) of the sample holding plate (141) to be supported, and a nozzle opening (not shown), through which a nozzle, as will be described below, enters and exits, is formed at the center of the sample holding plate (141).

The fluid compensation mechanism may comprise a base (150) on which components thereof are mounted; a fluid storage tank (160) which is fixed on the base (150) and in which a fluid is stored; a nozzle (174) which enters and exits said buckets to inject the fluid into the buckets (140) or suck the injected fluid from the buckets (140); a nozzle support (182) for supporting the nozzle (174) so as to be positioned at the middle of the buckets (140); an elevation plate (183) which lifts and lowers while supporting the nozzle support (182); a linear motion guide (186) and a linear bush (185) for guiding an up-and-down motion of the elevation plate (183) smoothly; an elevation motor (180) which is fixed on the base (150); a screw shaft (187) which is axially connected with the elevation motor (180); a slide center (184) which is fixed at the center of the elevation plate (183) and which is screwed with the screw shaft (187) by a female screw formed on the inner circumferential surface thereof; a position indicating marker (188) on which slits (188U, 188L) indicating the uppermost and lowermost positions of the movement of the elevation plate (183); a photocoupler (189) for the position sensor which is fixed on the elevation plate (183) and which comprises a light emitting element and a photodetector, which are installed on opposite sides of a groove into which the distal end with slits of the position indicating marker (188) is interposed. The fluid storage tank (160) has a fluid feeding inlet (161) in a given place, for example, on the top surface thereof, a fluid exhaust outlet (163) on a lower part of a side surface thereof, and a fluid sucking hole (162) on an upper part of the side surface thereof. In addition, the sucking hole (162) is connected to a sucking pump (172), and an exhaust pump (171) is connected to the fluid exhaust outlet (163).

In the above-described constitution, the center of the loading plate (133) of the load measurement mechanism (130) and the nozzle (174) of the fluid compensation mechanism are preferably located on the same vertical line. A reflective photocoupler type, a magnetic detection type, that is, a magnet and reed switch type, a potentiometer type, or a variable resistor type, and the like may be adopted by substituting the photocouplers for the slit disc (113) and the bucket positioning sensor (111) of the position measurement mechanism, and the photocouplers (134, 189) for the position indicating markers (135, 188) for measuring the positions which are installed respectively at the load measurement mechanism (130) and the fluid compensation mechanism. Furthermore, instead of using the exhaust pump (171) and the sucking pump (172), a single reversible pump, which integrates the two pumps, may be used. In such case, the fluid sucking hole, the fluid exhaust outlet, the connection tube, and the like can be integrated into one piece. Reference numeral “173” denotes the connection tube which connects the exhaust pump (171) and the sucking pump (172) to the nozzle (174).

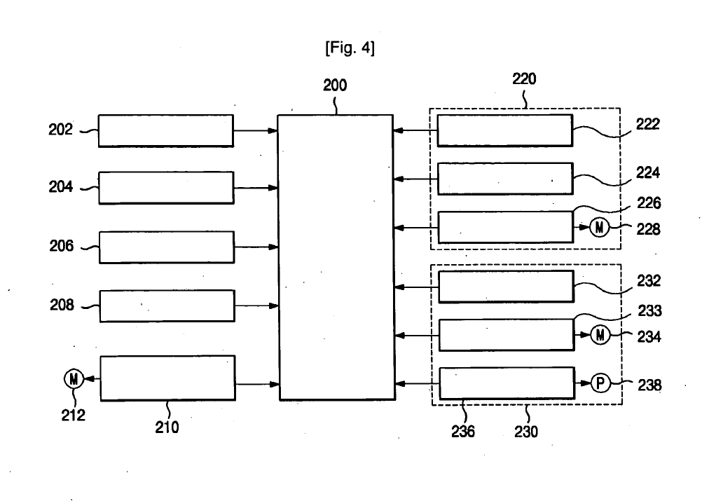

FIG. 4 is an electrical block diagram of the automatic balancing centrifugal apparatus by fluid compensation according to the present invention. For the sake of easier understanding, equivalent components in FIGS. 2 and 3 have been given different reference numerals. As shown in FIG. 4, the automatic balancing centrifugal apparatus by fluid compensation may comprise a key input part (202) for inputting or selecting various functions required for the apparatus; a speed sensing part (204) for sensing the rotational speed of the buckets (140); a bucket position sensing part (206) for sensing the setup position of the buckets (140); a display part (208) for displaying the input indication or the operating state; a centrifuge motor (212) and a drive part (210) thereof; a load measurement part (220) that is an electrical configuration of the load measurement mechanism (130); a fluid compensation part (230) that is an electrical configuration of the fluid compensation mechanism; a main control part (200) for generally controlling each of the components.

In the above-described constitution, the centrifuge motor (210) may adopt either an AC or DC motor having a speed control function and an electrical braking function, or a servo motor capable of controlling the speed and position. The speed sensing part (204) may comprise the speed sensor (112) and the peripheral circuit components thereof. The bucket positioning sensing part (206) may comprise the bucket positioning sensor (111) and the peripheral circuit components thereof. The display part (208) may consist of typical LEDs for displaying numbers or states or image displays such as CRTs or LCDs. The load measurement part (220) may comprise a position sensing part (222), which consists of the photocoupler (134) and the peripheral circuit components thereof, and a load sensing part (224) for sensing the load applied to the loading plate (133), and preferably, a piezoelectric sensor, an elevation motor (228) and the drive part (226) thereof. Likewise, the fluid compensation part (230) may comprise the position sensing part (232), which consists of the photocoupler (289) and the peripheral circuit components thereof, an elevation motor (234) and the drive part (233) thereof, the exhaust pump and the sucking pump (238) (or a reversible pump) and the drive part (236) thereof.

Hereinafter, the operation of the automatic balancing centrifugal apparatus by fluid compensation according to the present invention will be explained in detail for a case where four buckets are used, but not restricted thereto.

Firstly, the centrifuge motor rotates to position a bucket (a) above the loading plate (133) of the load measurement mechanism (130) by a sensing signal from the bucket positioning sensing part (206). The loading plate (133) of the load measurement mechanism (130) is raised up to the upper limit by a sensing signal from the position sensing part (222), and the load of the buckets (140) is measured by the load measurement part (224) while the restraint of the buckets (140) is released from the rotor arm. After the measured load is stored in a data memory (not shown) embedded in the main control part (200), the loading plate (133) is again lowered down to the lower limit by a sensing signal from the position sensing part (222). Subsequently, the centrifuge motor (212) rotates to position a bucket (c), which is axially symmetric with the bucket (a), exactly above the loading plate (133) of the load measurement mechanism (130) by a sensing signal from the bucket positioning sensing part (206). The load of the bucket (c) is measured in the same manner as the bucket (a) to be then stored in the data memory, and then the load differential between the two buckets (a, c) is calculated.

After the load differential is calculated, the elevation plate (183), that is, the nozzle (174), is lowered by the elevation motor (234) while the bucket of a smaller load is put on the loading plate (133), and the exhaust pump (238) is activated to introduce a fluid into the bucket (140) at an amount equivalent to the load differential while the load sensing part (224) senses the load of the bucket. The remaining two buckets (b, d) are compensated for the load differential in the same manner. Meanwhile, in a case where an odd number of buckets are used, after the load of each bucket is measured one after another, the remaining buckets are compensated a fluid equivalent to the load differential based on the heaviest bucket.

If the loads of all the buckets are equal to each other, the centrifuge motor (212) rotates to perform centrifugation. After the centrifugation is completed, the sucking pump (238) is actuated to suck all the fluid injected into each of the buckets (140) back to the fluid storage tank (160). Lastly, the centrifuged sample cylinders (142) are drawn out of each of the buckets (140), so the centrifugation processes are terminated.

The present invention is not limited to the embodiment disclosed but may be varied and modified within the scope of the following claims.

### INDUSTRIAL APPLICABILITY

As described above, the centrifugal apparatus of automatic balancing type by fluid compensation of the present invention does not need a slip ring since the rotor consists of a simple mechanism. Accordingly, the overall configuration of the centrifugal apparatus is simplified and the durability thereof is increased. Furthermore, since the structure of the rotor becomes slim, the rotor can mount a large quantity of or a plurality of buckets, and thus a relatively large number of samples can be processed at one centrifugation.

1. An automatic balancing centrifugal apparatus by fluid compensation, comprising:
(a) rotors on which a plurality of buckets are mounted;
(b) a centrifuge motor for rotating said rotors;
(c) a load measurement mechanism, which is installed so as to lift and lower within the rotation trace of said buckets;
(d) a position sensing mechanism for sensing whether or not each of said buckets is positioned above said load measurement mechanism;
(e) a fluid compensation mechanism for injecting a fluid into said buckets or sucking the fluid from the buckets; and
(f) a main control part for controlling the overall operations of each of said elements and controlling said fluid compensation mechanism so that the loads of said buckets can become equal to each other.

2. The automatic balancing centrifugal apparatus by fluid compensation according to claim 1, wherein the arms of said rotors have the same length from the center of a shaft and to be conformal to each other.

3. The automatic balancing centrifugal apparatus by fluid compensation according to claim 1, wherein said load measurement mechanism comprises:
(a) a loading plate to which the load of said buckets are applied;
(b) an elevation motor for lifting or lowering said loading plate toward said buckets (140);
(c) a screw rotation shaft which is axially connected with said elevation motor;
(d) an elevation shaft for supporting said loading plate with being screwed to said screw rotation shaft;
(e) a linear motion guide means for guiding a up-and-down motion of the loading plate;
(f) a load sensor for measuring the load applied to the loading plate; and
(g) position sensing means for sensing the uppermost and lowermost positions of the loading plate.

4. The automatic balancing centrifugal apparatus by fluid compensation according to claim 1, wherein said fluid compensation mechanism comprises:
(a) a fluid storage tank in which a fluid is stored and a fluid opening are formed in a given place;
(b) a nozzle which injects the fluid into said buckets or sucks the fluid from said buckets;
(c) pumping means which is connected to said fluid opening to exhaust the fluid to the nozzle or to suck the fluid from the nozzle;
(d) a connection tube for connecting said pumping means with said nozzle;
(e) a nozzle support for supporting said nozzle so as to be positioned at the middle of said buckets;
(f) an elevation plate which elevates and lowers while supporting said nozzle support;
(g) a linear motion guide means for guiding an up-and-down motion of said elevation plate smoothly;
(h) an elevation motor which is fixed on a base;
(i) a screw shaft which is axially connected with said elevation motor;
(j) a slide center which is fixed at the center of said elevation plate and which is screwed with said screw shaft; and
(k) position sensing means for sensing the uppermost and lowermost positions of the movement of said elevation plate (183).

5. The automatic balancing centrifugal apparatus by fluid compensation according to claim 4, wherein said buckets are formed as a cylindrical body with the lower surface closed, a plurality of sample holding holes for holding sample cylinders being formed within said buckets and a nozzle opening, through which a nozzle enters and exits, being formed at the center of said buckets.

6. The automatic balancing centrifugal apparatus by fluid compensation according to claim 5, wherein said pumping means is a single reversible pump capable of sucking and exhausting the fluid.

7. The automatic balancing centrifugal apparatus by fluid compensation according to claim 6, wherein the center of said loading plate and said nozzle are located on the same vertical line.

8. The automatic balancing centrifugal apparatus by fluid compensation according to claim 1, wherein said position sensing mechanism comprises a slit disc, which is axially connected with the middle of the motor shaft and in which slits indicating the positioning of each of the buckets are formed on the circumference thereof in a radial direction, and a bucket positioning sensor which comprises a photocoupler including a light emitting element and a photodetector, which are installed on the opposite sides of a groove into which the circumference of the slit disc is interposed.

9. The automatic balancing centrifugal apparatus by fluid compensation according to claim 2, wherein said position sensing mechanism comprises a slit disc, which is axially connected with the middle of the motor shaft and in which slits indicating the positioning of each of the buckets are formed on the circumference thereof in a radial direction, and a bucket positioning sensor which comprises a photocoupler including a light emitting element and a photodetector, which are installed on the opposite sides of a groove into which the circumference of the slit disc is interposed.

10. The automatic balancing centrifugal apparatus by fluid compensation according to claim 3, wherein said position sensing mechanism comprises a slit disc, which is axially connected with the middle of the motor shaft and in which slits indicating the positioning of each of the buckets are formed on the circumference thereof in a radial direction, and a bucket positioning sensor which comprises a photocoupler including a light emitting element and a photodetector, which are installed on the opposite sides of a groove into which the circumference of the slit disc is interposed.

11. The automatic balancing centrifugal apparatus by fluid compensation according to claim 4, wherein said position sensing mechanism comprises a slit disc, which is axially connected with the middle of the motor shaft and in which slits indicating the positioning of each of the buckets are formed on the circumference thereof in a radial direction, and a bucket positioning sensor which comprises a photocoupler including a light emitting element and a photodetector, which are installed on the opposite sides of a groove into which the circumference of the slit disc is interposed.

12. The automatic balancing centrifugal apparatus by fluid compensation according to claim 5, wherein said position sensing mechanism comprises a slit disc, which is axially connected with the middle of the motor shaft and in which slits indicating the positioning of each of the buckets are formed on the circumference thereof in a radial direction, and a bucket positioning sensor which comprises a photocoupler including a light emitting element and a photodetector, which are installed on the opposite sides of a groove into which the circumference of the slit disc is interposed.

13. The automatic balancing centrifugal apparatus by fluid compensation according to claim 6, wherein said position sensing mechanism comprises a slit disc, which is axially connected with the middle of the motor shaft and in which slits indicating the positioning of each of the buckets are formed on the circumference thereof in a radial direction, and a bucket positioning sensor which comprises a photocoupler including a light emitting element and a photodetector, which are installed on the opposite sides of a groove into which the circumference of the slit disc is interposed.

14. The automatic balancing centrifugal apparatus by fluid compensation according to claim 7, wherein said position sensing mechanism comprises a slit disc, which is axially connected with the middle of the motor shaft and in which slits indicating the positioning of each of the buckets are formed on the circumference thereof in a radial direction, and a bucket positioning sensor which comprises a photocoupler including a light emitting element and a photodetector, which are installed on the opposite sides of a groove into which the circumference of the slit disc is interposed.

15. The automatic balancing centrifugal apparatus by fluid compensation according to claim 8, wherein a plurality of slits for measuring the rotational speed of said buckets are formed on the circumference of said slit disc in a radial direction; said apparatus further includes a photocoupler for measuring the velocity, which comprises a light emitting element and a photodetector, which are installed on opposite sides of a groove into which the circumference of said slit disc is interposed; and said main control part controls the rotational speed of said centrifuge motor based on a sensing signal from said photocoupler.

16. The automatic balancing centrifugal apparatus by fluid compensation according to claim 9, wherein a plurality of slits for measuring the rotational speed of said buckets are formed on the circumference of said slit disc in a radial direction; said apparatus further includes a photocoupler for measuring the velocity, which comprises a light emitting element and a photodetector, which are installed on opposite sides of a groove into which the circumference of said slit disc is interposed; and said main control part controls the rotational speed of said centrifuge motor based on a sensing signal from said photocoupler.

17. The automatic balancing centrifugal apparatus by fluid compensation according to claim 10, wherein a plurality of slits for measuring the rotational speed of said buckets are formed on the circumference of said slit disc in a radial direction; said apparatus further includes a photocoupler for measuring the velocity, which comprises a light emitting element and a photodetector, which are installed on opposite sides of a groove into which the circumference of said slit disc is interposed; and said main control part controls the rotational speed of said centrifuge motor based on a sensing signal from said photocoupler.

18. The automatic balancing centrifugal apparatus by fluid compensation according to claim 11, wherein a plurality of slits for measuring the rotational speed of said buckets are formed on the circumference of said slit disc in a radial direction; said apparatus further includes a photocoupler for measuring the velocity, which comprises a light emitting element and a photodetector, which are installed on opposite sides of a groove into which the circumference of said slit disc is interposed; and said main control part controls the rotational speed of said centrifuge motor based on a sensing signal from said photocoupler.

19. The automatic balancing centrifugal apparatus by fluid compensation according to claim 12, wherein a plurality of slits for measuring the rotational speed of said buckets are formed on the circumference of said slit disc in a radial direction; said apparatus further includes a photocoupler for measuring the velocity, which comprises a light emitting element and a photodetector, which are installed on opposite sides of a groove into which the circumference of said slit disc is interposed; and said main control part controls the rotational speed of said centrifuge motor based on a sensing signal from said photocoupler.

20. The automatic balancing centrifugal apparatus by fluid compensation according to claim 13, wherein a plurality of slits for measuring the rotational speed of said buckets are formed on the circumference of said slit disc in a radial direction; said apparatus further includes a photocoupler for measuring the velocity, which comprises a light emitting element and a photodetector, which are installed on opposite sides of a groove into which the circumference of said slit disc is interposed; and said main control part controls the rotational speed of said centrifuge motor based on a sensing signal from said photocoupler.

21. The automatic balancing centrifugal apparatus by fluid compensation according to claim 14, wherein a plurality of slits for measuring the rotational speed of said buckets are formed on the circumference of said slit disc in a radial direction; said apparatus further includes a photocoupler for measuring the velocity, which comprises a light emitting element and a photodetector, which are installed on opposite sides of a groove into which the circumference of said slit disc is interposed; and said main control part controls the rotational speed of said centrifuge motor based on a sensing signal from said photocoupler.
